(19) United States
(12) Patent Application Publication
(10) Pub. No.: US 2014/0207611 A1
(43) Pub. Date: Jul. 24, 2014

(54) PERSONALIZED AUTOMATED SHOPPING SYSTEM AND METHOD

(71) Applicants: Elizabeth CLEARY, San Francisco, CA (US); Bianca KRAMER, Sausalito, CA (US)

(72) Inventors: Elizabeth CLEARY, San Francisco, CA (US); Bianca KRAMER, Sausalito, CA (US)

(21) Appl. No.: 13/492,552

(22) Filed: Jun. 8, 2012

Related U.S. Application Data
(60) Provisional application No. 61/495,900, filed on Jun. 10, 2011.

(51) Int. Cl. G06Q 30/06

(52) U.S. Cl. CPC G06Q 30/0633
USPC 705/26.8

(57) ABSTRACT

A personalized, automated shopping system and method includes generating a virtual hold tag in a shopping application on a computer that provides one or more items for sale to a consumer operating a client computing device. The shopping application is associated with a retailer of the one or more items. The system and method includes associating at least one of the one or more items with the virtual hold tag in the shopping application, and generating a collage of items associated with the virtual hold tag, the collage of items being a single visual representation of each item associated with the virtual hold tag. The system and method further includes transmitting the collage of items to the consumer via the client computing device, and providing, for the client computing device, an interface configured to allow the consumer to buy, hold, or decline each item in the collage of items.

### CROSS REFERENCE TO RELATED APPLICATIONS

This application claims the benefit of priority under 35 U.S.C. §119 to U.S. Provisional Patent Application Ser. No. 61/495,900, filed on Jun. 10, 2011, entitled, “Personalized Automated Shopping System And Method”, which is incorporated by reference, herein, in its entirety.

### BACKGROUND

This disclosure relates generally to electronic commerce, and more particularly to a personalized automated shopping system and method.

The current market for luxury retail goods is approximately $48 billion in the U.S., and globally at about $166 billion. However, only $2 billion of that worldwide spending is currently done online. There are a number of reasons for this.

Although mainstream online shopping continues to increase at a fast clip year over year, luxury retailers remain skittish about selling their goods online. They acknowledge the significance of the internet as a channel, but view it mostly as a channel for branding and promotion, not for selling or distribution. Although 40% of luxury designers think the online channel will produce the majority of their revenue in 10 years, the majority of them still sell only through a handful of online retailers.

Although most consumers assume that luxury goods are sold in the same manner as mainstream goods, luxury retailers in fact retain much of the personalized service they have offered since the days of showrooms, live models, and pre-ordering for the season. Luxury retailers typically operate by what they call the 20:80 rule: 20% of their shoppers account for 80% of their revenues, and those 20% are given very personal, direct service. Most salespersons at luxury retailers maintain a number of contacts with their most important clients. When a new product collection is available (and often before it is available), phone calls are made or emails sent to their clients, letting them know that they have hand-picked a number of items for each client and put them “on hold” for some amount of time, typically 48 hours. Often, the emails will include photos of the items. A dialog ensues between the salesperson and the client. Clients may then come into the store to try on items in private fitting rooms, but more typically request that the chosen items are shipped to them for try-on at home, where they decide what to keep and what to ship back for return. This selling practice is one of the reasons that there are typically very few shoppers in a physical luxury store at any one time. The more successful stores manage their business with their core clients outside of general walk-in clientele. The storefronts act as marketing and branding arms, as well as sales offices from which the salespeople outreach to their clients.

Because luxury retailers thrive on their salespeople's relationships with personal clients, it has been difficult for them to consider moving sales online, i.e. to a convention web-based online store, or “webstore”. Their best clients do not typically shop by taking the time to browse hundreds of items, and instead rely on their salesperson to curate the clothing for them and provide recommendations. In the early days of online shopping, luxury retailers also feared tarnishing their brand by going online, and feared that their goods would be more easily knocked off. That fear has largely diminished. Now, however, luxury retailers only continue to move slowly and reluctantly online because they think a traditional webstore does not fit their strategy, they dislike its impersonal nature, and do not think their customers will purchase from such a site. Further, such a shift in strategy requires a significant investment in information technology (IT) and marketing, neither of which to date for luxury retailers has shown a return on investment.

While most mainstream retailers are creating a new online channel for their goods, luxury retailers are still in wait-and-see mode, letting a few large luxury retailers act first. In the meantime, their reticence about online offerings is limiting their audience rather than broadening it. This also makes them appear archaic to the majority of their client customers who already shop with their stores virtually (albeit via phone, email and charge-sends), are increasingly comfortable shopping online, and who would often choose online versus in-store shopping if it were more convenient and available for luxury goods. In fact, the latest research data shows that luxury consumers follow luxury fashion very closely online, and are early adopters of mobile and online technology.

Early movers in luxury online retailing have shown great promise. Some have seen average online growth of 21% per year, even though the luxury retail industry as a whole typically averages just 8% growth per year. Consumers of luxury goods appear to be comfortable purchasing luxury goods from reputable sites, even when those sites do not offer the personalized service to which they are accustomed.

Luxury consumers are also open to shopping online for luxury goods, whether they do so now or not. The luxury consumer is typically a hard-working highly successful executive or self-made, high-income consumer. Contrary to popular belief, only 6% of luxury retail customers have inherited their wealth. They also shop online more often than average consumers, and 88% of them do their research online for luxury buying decisions even though most of their purchasing is still offline. In addition, 62% of them are comfortable purchasing apparel online, with an average comfort threshold of a $3294 price tag on average. Even more telling, however, are the reasons for shopping for luxury online provided by consumers who already do so: typically, they are cash-rich but time-poor. In addition, they appreciate the anonymity of purchasing online and the privacy of trying on items at home. They appreciate having no perceived obligation to buy when browsing an online store, with a significant number of affluent consumers indicating that they find luxury stores intimidating and overwhelming, and resist the forced relationships with too many stores. Lastly, 50% of these consumers do not live near traditional “brick & mortar” luxury stores, and online shopping gives them additional access beyond the shopping trips they do a few times a year.

Establishing a webstore, however, causes luxury retailers to worry about losing their personalized touch, as well as pay significant administration and maintenance costs. Yet, luxury retailers find it difficult to successfully portray their goods without spending a lot of time and money, and they worry about what will happen to their physical store sales. Online inventory is different from that found in local, physical store, sometimes for the better and sometimes for the worse. Overall, online shopping for the luxury consumer is often a game of chance, and the consumer is often forced to wait until they can get to a physical store before they make a significant purchase.

The lack of personalized service online is a loss also felt by luxury consumers, not just retailers. When shopping online, surfing, searching and sifting are the norm, making the online experience frustrating and time-consuming instead of easy and time-saving. The volume of merchandise is immense, and there is no service element as there might be in physical stores. A shopper can consume multiple hours just to browse, making it difficult and inconvenient to “window shop”. The consumer must know what they want, and the process is only convenient for simple purchases, not as well equated with the joy of shopping.

In luxury brick-and-mortar stores, store salespersons act as experts who curate for their clients from the thousands of items in each store, pushing items to clients who respond both positively and negatively, allowing salespersons to tune their future suggestions based on these responses. This is decidedly different than the current online shopping experience, which relies on clients spending a considerable amount of time browsing and searching, and then purchasing without any help from the store itself, nor with access to the vast majority of inventory locked in brick-and-mortar stores rather than available online. Other online sites rely on electronic recommendation engines to suggest related or possible items, largely to hit-and-miss effect. It is still very difficult to shop online, and commerce engines are not reliably good at styling a personal wardrobe.

What is needed is an online platform that can resolve the issues set forth above, and provides luxury retailers with the tools to foster their client relationships online, as well as provides an online operation that helps their physical stores, not competes with them. The online platform must also provide increased volumes and salesperson productivity, and to a broader market.

### SUMMARY

In general, this document discloses web-based systems and methods for personalizing and automating luxury shopping and optimizing the entire shopping and selling process.

Consistent with various implementations described herein, the systems and methods provide a powerful and comprehensive online sales and merchandising tool for luxury retailers, integrated in a shopping site. The systems and methods serve luxury consumers by providing a superior shopping experience with simple, intuitive features and tools that streamline the mechanics of shopping online, thereby reducing time spent shopping while increasing the ease of finding items for purchase. Further, the systems and methods create appeal for the solution through clean and reliable presentation and connectivity, as well as commonality with existing operational processes in retail stores, and provide an easy to use, concise product feature set that facilitates easy shopping of a high volume of inventory that is high-quality, available and authentic.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a personalized automated shopping system.

FIG. 2 illustrates a method in accordance with implementations of a personalized automated shopping system.

FIGS. 3-7 illustrate various user interfaces on various computing platforms for executing a personalized automated shopping method.

Like reference symbols in the various drawings indicate like elements.

### DETAILED DESCRIPTION

This document describes a web-based system and method for personalizing and automating luxury shopping and optimizing the entire shopping and selling process. The system is client-server based, with the server platform hosting and serving a website and managing the process functions, while accepting requests from and providing responses to a client application within browsers on end-user client computers. End users are defined on the buying end as the consumers who purchase luxury goods on the website, and on the selling end as retailers' sales staff who offer items for sale on the site. The base platform is preferably a remote server, with a client application running within standard web browser windows on the client computers.

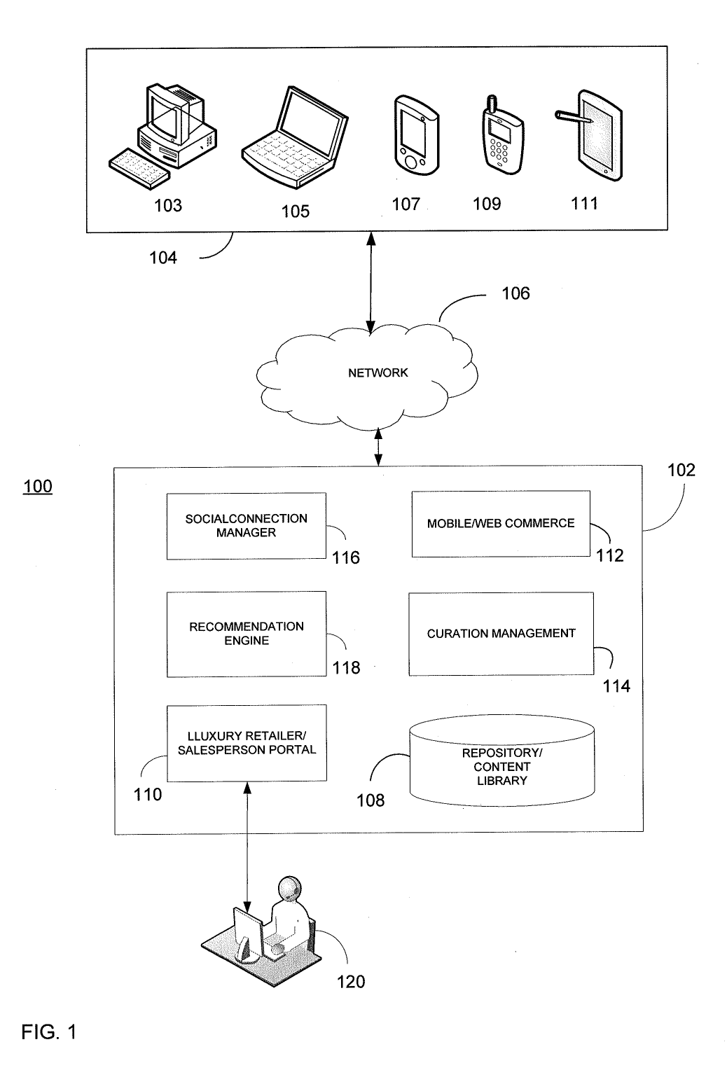

FIG. 1 illustrates a personalized automated shopping system 100. The system 100 depicted is for example only, and those having skill in the art would recognize various different ways of architecting such a system to achieve the same new functionality as described herein, or achieve similar results. The system 100 includes a personalized shopping server 102 that interacts with a number of client computers 104 via a network 106. The server 102 can be one or multiple servers, such as mirror servers, application servers, or the like. The network 106 can be any wired or wireless network, or combination thereof, and collectively represents the World Wide Web (i.e. “the Web”).

The client computer 104 can be any of a desktop computer 103, a laptop computer 105, a smartphone 107, a cell phone 109, or a tablet computer 111. In essence, each client computer 104 simply requires an operating system that can host a browser application and one or more locally-executed applications, such as local instantiations of functionality from the shopping server 102 of the personalized automated shopping system 100.

The shopping server 102 includes a mobile/web commerce module 112 for conducting commercial transactions, such as a shopping cart, credit card hosting and charging, automated clearing house (ACH) functions, customer verification and management, and other functions. The shopping server 102 further includes a curation management module 114 to enable personalized shopping services between a salesperson 120 that can access the system 100 and any number of customers using a client computer 104. The curation management module 114 executes a number of functions described below. The shopping server 102 further includes a social connection manager 116, a recommendation engine 118 that makes item recommendations based on a user's historical transactions and profile information, and a luxury retailer/salesperson portal 110 for managing communication with the salesperson, and for communication with the client computer 104. The shopping server 102 also includes a repository/content library that stores data related to transactions executed by the shopping server 102, as explained in further detail below.

The system operates on a user account basis, where users create an individual unique login and password to access features. Specific features are displayed or hidden depending on a user's categorization. The system enables categorization of end users. For instance, in one exemplary preferred implementation, there are three core categories of users: consumers, retailers, and administrators. Each type of user has a different set of features that pertain to their function. Consumers are those whose primary function is to shop and purchase items on the site. Retailers are those whose primary function is to post and sell items to consumers, as well as review and analyze reports regarding the selling of their store items. Administrators are internal system users who maintain and adjust the site's content, features, and functions, as well as resolve any issues about underlying operations.

The website provided by the system is sophisticated enough to display different features based on a user's sub-categorization within the above categories. The site can limit features based on the specific type of retailer or administrator user, and have the ability to offer special features to different levels of consumers, e.g. higher spending consumers versus consumers who have not purchased as much. The site can offer a consumer loyalty program with points accumulated according to past purchases, as well as a salesperson loyalty program with points accumulated according to past sales, where special offers or special features will be offered to these different sets of users.

The following feature requirements, user attributes, needs, and buying scenarios are consolidated into a set of luxury shopping functions. The interface for these functions is preferably web-based so that client software does not need to be installed on each client's desktop machine.

Create Retailer Account

Creating a retailer account within the site creates a specific “domain” for retailer administrators, salespeople, their clients and their inventory to be engaged in private commerce with the clients connected to that retailer. Each retailer also automatically engages in public shopping, where the items offered to connected clients are also automatically offered to the public, albeit without knowledge of the client for whom the items are intended. The retailer can decide how much to participate in either activity, dependent on the specifics of their business or their store's seasonality.

Certain system objects that start out “belonging” to a single retail account can also belong to the accounts of other retailers. For example, clients can often belong to one or more store domains, simply because consumer clients do not often shop only with one salesperson at one store. In that case, none of the private shopping activity by that one client at one store is shared across stores. However, access to private shopping with that client may be available to more than one store. In another example, inventory will also likely belong to more than one retail account since most items of apparel and accessories are of course offered at multiple stores.

In order to setup a retailer account on the system, basic information needs to be provided. When a retail administrator is logged in, they can edit this information anytime.

Contact Information

A retail administrator provides general contact information such as name, address, etc., plus additional information that is needed to engage in private and public shopping.

Salespersons Accounts

The names and contact information of salespeople is added to the account, providing information on who will have the ability to engage in private/public shopping on the system on behalf of a retailer. This connection between retailer and salesperson also ensures that all data and notifications display properly in the appropriate UI workflows as well as reports, etc. Once a salesperson's account has been established, with a default password, an activation notification is sent to that salesperson to create a custom password and begin using their account.

Manager Accounts

A retailer has the ability to create Manager accounts, where Managers are salespeople who are also able to see the account information/activity of their direct report employees.

Buyer Accounts

A retailer creates Buyer accounts, where Buyers are primarily involved in the input of inventory data for each season, which the salespersons and managers access as they engage in selling and marketing on the system site.

Rules

A retail administrator is able to set certain rules by which their Salespersons and Managers usage must abide, where the workflow of the system's features follow such rules:

1. Hold Time

Any item on the system can be placed “on hold”, where a hold is a short time period where an item is available exclusively to a single client or consumer for consideration or purchase. Such an item is still within a store's inventory, but is not available for sale to any other person than the client for which it is on hold. The hold time allows a store to define the maximum amount of time that an item can be on hold. In some implementations, a global minimum and maximum hold time is used, and within that range a store can set their specific minimum and maximum.

After an item is held for a set amount of time, e.g., 48 hours, and its hold time expires, it is no longer be considered on hold within the system, and is available for other consumers to purchase, or for other salespeople to put on hold for a client.

2. Notification Method and Frequency

Notifications are delivered to each user in core workflows throughout the site, depending on the activities that have been completed or need to be completed. In addition, retailers can further identify a frequency and a method or medium of notifying their salespersons and managers outside of the site, e.g., by SMS text to their phone, or by email message to their existing email account. The retailer can set this as a per-store rule as well as per-salesperson if desired.

3. Shipping and Return Rules

Certain global shipping and return rules are set by the system, and within those rules, a retailer can customize the shipping and return decisions a consumer/client can choose as they interact with that store. In general, the global settings are centered around different options for shipping methods and the costs for such charges, plus the maximum amount of time a consumer can take to return or exchange an item. All stores are required to accept returns within a certain time period.

Create/Edit Retailer Profile

Once a retailer has created their account, they can add promotional profile information to it, which will give other users more information about the store, regardless of whether the store is known to a consumer or not. The retailer profile inherits some basic aspects of the account information that is considered public (e.g., name, location, salesperson names, etc.), in addition to the following promotional information:

1. Store Profile

A retail administrator has the ability to input a high-level, limited description of their store written in free text, which in some exemplary preferred implementations is approximately a paragraph. In addition to that free text, the store can provide answers to a few questions that will provide even more information to consumers, e.g., vision or style of the store, history, etc.

In addition, the store provides a logo and/or photos, likely via a store template generated and/or provided by the system. The store can also choose the color and/or style from a set of multiple templates.

2. Salesperson Profile

Each salesperson provides promotional profile information about themselves, first inheriting information from their retailers' input: name, store, location, etc. The profile information includes contact information as well as a high-level, limited description of the salesperson and their style point of view, written in free text. They can provide answers to questions sought by questionnaire. Like the stores, the salespeople can upload a photo, as well as eventually choose for their profile to be displayed within a specific template designated by their store. The system can also provide the ability for each salesperson to provide blog entries, which will allow them to further communicate with their clients.

Create Store Inventory

Once a store account has been created, an inventory of items is added to the store's account, where an item is a single piece of apparel or an accessory that a store wants to offer for sale.

Associate Items to Store

Populating an online store's inventory takes place in close partnership with the store. Initially, a store's inventory can be populated with items that the store knows they have purchased from designers/manufacturers for an upcoming season (typically 6 months ahead of when those items will physically arrive at the store). That inventory information is provided to the system mainly from the store's buyers whose job it is to place such orders. Once added, the item is associated with that store and “belongs” to it, but it is also added into the global system inventory, in order for system administrators to associate it with other stores' inventory as well. Each item is thus be associated with at least one store, but can be potentially assigned to multiple stores. The system can also obtain item information and photos from a variety of designers, populate the global system inventory with that data, and then allow stores to associate the appropriate items to their stores on their own.

Global Descriptive Information

Each item has associated with it some basic descriptive information about the item, which is preferably universal to the item no matter which store carries it:
Designer

Designer's name, ideally chosen from an existing list of names. Each item preferably has one designer name.
Name/title

Short descriptive phrase describing the item, including the model/style name as appropriate, e.g., printed silk-chiffon dress, or Perfeto leather biker jacket. Each item preferably has only one name/title.
Model number

Item's model number as stated by the designer/manufacturer. This may be different from the SKU number that the retailer uses to keep track of the item in their own inventory system
Category/type

Type of item, chosen from major categories such as skirt, pant, top, dress, coat, jacket. In certain cases, items may be associated with more than one category.
Color

Main color of the item as stated by the designer/store. This attribute may also be stated as multiple values. Other attributes can also be used to track globally per item.

Store-Specific Descriptive Information

In addition, there are a number of store-specific attributes that can be associated with each item, where the values of these attributes may be different per store, and are preferably not shared across stores. When an item is associated with a store (e.g. by virtue of them send it via hold tag), the item inherits this store-specific information as well as the global information.
Store SKU number

Item's SKU number that the retailer uses to keep track of the item in their own inventory system. This may or may not be the same as the model number stated by the designer/manufacturer.
Size(s)

Size of the item as stated by the designer. This may be stated as multiple sizes, and the system site can allow for this. For example, a dress size may be stated as both a European size 42 and US size 6.
Price

There is a main MSRP price as stated by the designer/store, plus the ability to state a discounted/sale price when an item's price is reduced. When a discounted/sale price is established, it does not replace the original MSRP price. Instead the system allows for both, with one of the prices set as the current or default price of the two.

Differently from the other item attributes, the MSRP pricing value can be shared across stores, but each store is able to override that price and set their own. Any discounted/sale price can be completely specific to each store, and not shared across stores at all. This is important, as often a store will discount an item at a different time than one of its competitor stores, and knowledge of the markdown is preferably not shared.
Quantity in stock

The quantity of each item reflects the quantity that the store has in stock or expects to have in stock once the item arrives, and is specific to each size (e.g., 5 qty of size 6, 10 qty of size 8, etc.). This attribute is store-specific, though the data will not be integrated with the store's actual inventory system. Store employees can update the system to alter the quantities when items are physically sold out of their store.

Photos

In addition to descriptive attributes, the system provides the ability to associate photos with items, at least one per item, though multiple photos are preferred and enabled.

Associate Photos within Library

Each item has at least one global photo that can also be the default photo, where an administrator associates an item with a photo in the system content library. This can be done by an internal administrator, and allows them to associate multiple global photos to any item.

Nice-to-have: When photos are loaded into the library with white or light-colored backgrounds, the background portion of the photos is auto-eliminated, to allow items to be more stylishly featured on the system website.

Upload Photos

Once core photos are loaded per item to the site, stores are also able to upload and associate multiple other photos with the item. This provides the ability to upload a photo from a connected camera, to perhaps give a more specific point of view on the item or to utilize photos that a store may have already taken of their inventory, e.g., for their own website. By default, these photos are global, but salespersons can have the ability to make them store-specific so that they are private to the store and their clients. Consumer users can utilize this feature as well, though photos uploaded by consumers are considered global photos for all to see rather than specific to any store.

Link Online Photos on 3rd Party Site

Stores and users can link an online photo found on a 3rd party site. However, when clicking on such a photo, no redirection to the 3rd party site actually takes place.

Item Status

Once an item is associated with a store's inventory, each salesperson can view the items as well as utilize an item within a private or public shopping interaction. In exemplary preferred implementations, there are six distinct status states for any item within a store's inventory. In general, they are as follows, although one of skill in the art will recognize that any number of states and status designations can be used:
Available
Available for any salesperson to access and offer in system features
Hold requested
Unavailable for salespersons to access/offer, and assigned but not yet confirmed to be on hold for a specific consumer
On hold
Unavailable for salespersons to access/offer, and confirmed to be on hold for a specific consumer for a specific period of time.
Purchase requested
Unavailable for salespersons to access/offer, and assigned but not yet confirmed to be purchased by a specific consumer
Purchased
Unavailable for salespersons to access/offer, and confirmed to be purchased by a specific consumer
Return requested
Unavailable for salespersons to access/offer, but possibly becoming available soon

Different shopping interactions can alter the status of an item with the store inventory, as described in more detail below. In addition, manual status alterations are available to salespersons, buyers and managers on a more global basis, which allow them to adjust their online inventory due to activities that are happening in their physical store rather than online. They can edit the status that an item has been put on hold for a client, sold or returned, even if a client does not yet have a client account. This helps stores efficiently keep their inventory status up to date, as well as accurately understand what they can and cannot offer to clients online and track all of their store's inventory activity.

Salesperson-Client Connections

Once a store is setup with an account and their associated salespersons, the store can connect to their existing clients, and vice versa, clients can connect with their salespersons. When a salesperson-connection exists, the system site allows a salesperson to interact with that client using specific private shopping features not available for use with disconnected consumers. The social networking aspect of the site is a very important one that allows salespeople and their clients to connect and shop privately, the main thrust of the site. There are a number of ways that a client account can be created, and the site will encourage connection to at least one salesperson.

The main connection mechanism is accomplished via a request-accept connection function, whether the client already has an account on the system or not. Each client has the ability to connect to multiple salespersons at multiple stores, as is the norm in salesperson-client relationships in luxury retail. Consumers can also connect to other consumers, where the interaction and features may be different. Stores and their managers have oversight access to the client accounts of their salespersons and in general, a client account is co-owned by both store and salesperson.

Salesperson-Requested Connection and Client Accounts

Salespersons are able to provide client contact information to create a connection to their existing clients. Connections are available for clients whose name and email or mobile phone number is known to a salesperson. When inputting such information, the system automatically establishes the salesperson-client connection and creates a system account for the client, herewith called a “pre-account”, where activity can be attributed to the account, even if that account has not yet been confirmed by the client. This allows salespersons to interact with their clients using the system even if the client has not deliberately acknowledged such an account, nor provided any other information to complete the account, nor created a password to better manage the information and content in the account.

Once a connection is created, an invitation to connect is delivered to the client via email or phone (i.e. via a messaging application such as SMS), with a link to review and confirm. Once the client confirms the account, their pre-account is converted to a full account in use by the client, where they can login and manage all of their activity.

If a client's contact information already exists within the system, where the client already has an account, then the invitation to connect is generated without needing to create a new account. If/when client accepts invitation, then that salesperson-client connection is established within the already-existing account.

This is not to imply that salespersons will be able to browse a list of consumers with whom they may want to connect. On the contrary, such a list is preferably never available to salespersons, so as to prevent the unwanted invitation blast from salespersons to hundreds of consumers with whom they do not already have a real-world relationship. Instead, the salesperson can only connect with clients whose contact information they already possess, or consumer/clients who contact them.

If a client ignores such an invitation, a reminder is sent after a time period, with a personal note to the client. If the client still does not accept the follow-up invitation, it is up to the salesperson to follow-up in a different manner, e.g., via phone. The system can generate and transmit an incentive to both salespersons and consumers who create a system account and connect to a salesperson, so tracking of such connections will be important.

Client-Requested Connection

Consumers are able to create an account by requesting to be connected to a salesperson they know or one they find on the system site.

Client Account Attributes

A client's pre-account at minimum includes the client's first and last names, and at least one piece of electronic contact information, whether that is email or phone number. For shipping purposes, it is important to obtain their mailing address, however. As stated previously, a client is free to interact with their connected salespeople via a pre-account, although they preferably do not have access to the full use of the site until they setup a password to convert to a full account. When using a pre-account, clients are able to receive private looks pushed to them by a connected salesperson, and indicate whether they would like to buy, hold or decline any item or the whole look.

Full account information includes all manner of other standard account attributes, including but not limited to: gender, credit card information, loyalty/reward program numbers for different stores, etc. An account also includes a username or alias, to provide further privacy to users requiring it. The username/alias rather than their official first/last name is displayed with the user's profile to connected salespersons.

Agreement to T&Cs

When creating an account, the user is required to agree to a terms & conditions agreement, as well as a privacy policy.

Create/Edit Consumer Profile

A profile is a set of attributes that the consumer would like to convey about clothing sizes, likes and dislikes, which gives both the system site and salespersons the information about items that their client would be more interested in and not. A profile is viewable by salespersons with whom a client is connected, for the purposes of further educating a salesperson about a client's shopping habits.

Within the context of public shopping, the profile is used as a simple filtering mechanism, allowing the system to tune which items to show versus hide to a connected salesperson for that consumer. However, over time it will be further used for more sophisticated recommendations, etc. It is not required that consumers input and maintain personal information in their profiles, however. They are free to leave it completely free of attributes if they so choose.

Profile Attributes

A consumer/client profile includes a set of attributes for users to indicate their preferences against, with multiple values per attribute. Basic attributes include category types, preferred designers, sizes, colors, etc. Important profile attributes the system site utilizes are the size attributes, which helps both salespersons and clients in their interaction with the site. For salespersons, it will help them suggest only those items that will fit their clients. For clients, it will help them view only those items that will actually fit them, saving time. More information on the use of sizes in the shopping experience will be detailed below.

Because of this use of profile information to filter user views, multiple values per attribute are supported, and profiles also support the ability to create “and/or” combinations of multiple attributes that include sizing, e.g., “Skirt in size 8”, or “Pants in size 6 or 8”. Other attributes, such as designer, can be used where users specify their sizing in terms such as “Calvin Klein, dresses, in size 6 or 8”. Profiles also support both negatives and positives on an attribute, where users state values of an attribute that they like as well as dislike. This is especially important for salespersons to understand what they should not recommend to a client.

A consumer/client profile is a set of attribute values that change over time, not to be thought of as the more static account information. Users can change preferences for designers, sizes and types of clothing they desire over time, so use and application of this data is nimble within the system's architecture.

Salesperson-Edit of Client Profile

Once connected, a salesperson is able to suggest changes to their client's profile. Clients are notified of any change, and are able to accept or decline each change made. This feature is accessible to the salesperson at any time, where they can setup their clients' profiles at the beginning, as well as tune them over time.

Other features that are executed by a computer processor in the system include:
Assumed attributes: User input of value for one attribute determines values for multiple other attributes indirectly. E.g., a user takes a short personality quiz where the answer for each question sets the values for multiple attributes.
Nuanced values: Provide more nuanced values for attribute, e.g., ‘somewhat agree’ versus ‘disagree strongly’ rather than just absolute values, where there can be a mix of absolute values and non-absolute values.
Custom attribute: Be able to input clear text to create a custom attribute.
Custom privacy settings: Ability for consumer to set privacy values on individual attributes for specific connections that they are able to group for such purposes.
Incorporate purchasing activities: As consumer uses site, their profile/display are tuned based on what user purchases, not just preferences that user entered via quiz/survey.
Incorporate browsing activities: As consumer uses site, their profile/display are tuned based on what user browses in detail (e.g., clicks on an item to review detail, not just preferences that user entered via quiz/survey).
Incorporate simple feedback: As consumer uses site, their profile/display is tuned based on thumbs up/thumbs down type of rankings user gives to items and/or review comments made, not just preferences that user entered via quiz/survey.
Ability to have multiple profiles per account, e.g., when one person does the purchasing for multiple people in the household.
Copy friend's profile: Friends are able to use each other's profile as a starting point to create or enhance their own profile.

Establish Consumer Closet

A consumer's “closet” is their virtual representation on the system of all items purchased on the system or stored in their actual physical closet. A consumer's closet is viewable by all connected salespeople, giving salespeople more nuanced information about a client's shopping habits and which new items they may want to suggest for them.

Purchased Items

All purchased items are added to a user's closet, where baseline information about that item is displayed, but all pricing, store, salesperson and date purchased information is not. That is, information on the other stores and salespersons that the client shops with is preferably not shared, nor is any pricing information shared. Baseline information about each item includes designer, item category, color and size. The name/title and the model number are added if available, but neither is required. Whenever an item is returned, it is removed from a user's closet.

Non-System Items

The user is able to add non-system items to their closet by uploading a photo of any item and providing baseline information about it. This feature helps give salespersons more information about a client's tastes even if they haven't bought much merchandise via the system. Both salespersons and clients are able to add items to a client's closet, though a client is notified of any item added by a salesperson, so that they can review/approve any addition.

Private Shopping

Private shopping is a term used for a different type of ecommerce shopping mechanism, whereby salespersons and their clients connect and interact via private suggestion and response rather than the standard hunt-and-peck browsing and searching that is the norm for online shopping according to other implementations. The connection and subsequent suggestion-and-response interaction is a key differentiator for the system, allowing both stores and their clients to mimic online the standard ways in which they interact in real-world shopping.

Although over time the system site will begin to understand patterns of user-specific behavior that can electronically suggest items, at its core, the system utilizes the salespersons' expertise in curation as the key driver of the user experience. It will help salespeople become even better curators for their clients, and help clients become even more efficient online shoppers. Because the vast majority of available items are still inventoried in brick and mortar stores, not at the few luxury stores online, the system's private shopping feature provides a highly efficient and convenient way for shoppers to access these items across the US, while leveraging the salesperson expertise already available at each store. In turn, the stores will be able to more efficiently and conveniently interact with their current clients in a private manner, while marketing their store and inventory more publicly to easily gain additional new clients.

Creating Hold Tags and Style Sheets

Once connected, a salesperson is able to create “Hold Tags” or “Style Sheets”, which are virtual containers for a suggestion of items to a connected client. The difference between the two objects is that a hold tag mimics the standard in-store practice of exclusively setting aside items for a client for a set period of time, where that client can visit the store to try them on, or can purchase them in store or via phone or email conversation. A style sheet is a suggestion of items for a client, but those items would not be set aside for that client exclusively, and could be sold to other clients. Style sheets are analogous to notes sent by store salespersons to their clients to suggest that the client should visit the store soon because there are a number of items that the salesperson thinks they might like, where there is no commitment from either salesperson or client.

Create Hold Tags

A hold tag electronically performs the same function as an in-store hold tag, and additionally acts as the push mechanism for salespersons to market and sell items to their clients. When creating a hold tag for a single client (cannot create a single hold tag for multiple clients), the salesperson is able to select items from their online store inventory and add them to a hold tag. Those items are placed on hold status, where they are temporarily unavailable to any other client or consumer, though they still exist in the store's inventory.

The salesperson can immediately send a hold tag by the system over a network to their client or save multiple unsent store tags for later sending. When a hold tag is saved, the salesperson is able to edit it by adding or subtracting items. This saving function allows the salesperson to queue up hold tags, editing them along the way, and then sending them all at once when they are finally satisfied with the choices they have made for their clients.

Once sent, any item on a hold tag is ‘on hold’ for that client for the time period designated by the store as their standard hold time (e.g., typically 24-48 hours). Once a hold tag is sent to a client, the countdown on the hold time starts. The store salespersons cannot override or extend their store's standard hold time, though such a feature can be provided as an option.

At some point in the hold tag creation process, it is up to store salespersons to physically set aside such items in the stores. In some stores, this will take place before the system process is started, and in other stores it will take place during the process (e.g., client by client). It is up to the stores to synchronize their in-store process with the system process.

Create Style Sheets

Creating style sheets follows a similar workflow pattern as creating a hold tag, with some key differences. First, because a style sheet does not exclusively hold items for a client, nor does it even guarantee that such items will be available for purchase when the client receives the style sheet, a salesperson is able to create a single style sheet for an individual or multiple clients. That is, they are able to use it as a tool to send personalized recommendations to individual clients, or to send a blanket recommendation to many clients at once. Secondly, there is no time expiration on style sheets since none of the items are actually on hold. Lastly, the status of any item will not be altered from its available status by virtue of its addition to a style sheet.

Filter Inventory by Client Profile

When adding an item to a hold tag, the system filters items to match a client's sizes or preferences from their profile, or both. This makes it easier for salespersons to be both efficient and correct in their suggestions. Salespersons are able to choose whether the filtering for sizes and preferences is on or off, though the default setting is that filtering by size is always on. It also prompts them with a warning note if an item does not match the client profile, but still allows the salesperson to add an item via an override. Any override is indicated to both the salesperson and the client on the hold tag.

This filtering is utilized when creating a style sheet for an individual client, but automatically turns off when multiple clients are added to a style sheet. Although filtering is helpful when creating style sheets for an individual client, it does not make sense when items are being recommended to multiple clients.

Add Notes to Hold Tags/Style Sheets or Items

The salesperson or client is able to add a personal note in free text to any hold tag or style sheet, or to any individual item. Such notes are considered a part of the hold tag/style sheet/item rather than completely separate messaging entities. Notes about items help to personalize the selling effort, but such a mechanism is not meant to act as a full-blown message system. It is much more helpful to both salespersons and clients when any note is always directly connected to an item in question or a hold tag/style sheet.

A client is able to reply back to any note or start one on their own via the system. These note “conversations” can start at the point that a salesperson suggests an item to a client, or when a client views an item (whether while engaging in private or public shopping). All responses from the original note are part of the same hold tag/style sheet/item, where a trail of multiple back-and-forth responses are tracked within the context of a hold tag/style sheet, analogous to an online chat rather than a series of separate email messages.

Any chats about an item that take place are considered private and remain viewable only by the client and the salesperson who is selling the item to the client, as well as the salesperson's manager. In exemplary preferred implementations, once an item is purchased and is in a client's Closet, new private note exchanges between a client and any other connected salesperson is possible. This feature helps both sets of users privately converse about various items regardless of where they were purchased. For comments on closet items, connections other than salespersons are able to make private comments about individual items in a client's closet. Private comments are preferably only seen by the commenter and the owner of the profile.

Privacy of Hold Tags/Style Sheets

When sent, the hold tag interaction between salesperson and client is private. On the client side, this means that the client is able to view the items and notes sent to them, and their account/profile is only displayed to the salesperson, not to any other client/consumer on the site. This is true even when a single style sheet is sent to multiple clients—each client does not know the other clients to whom the style sheet was sent.

On the salesperson side, they are able to view the hold tags and style sheets that they sent, but not any sent by other salespersons, unless they are a manager user in the system, where they are then be able to see the hold tags/style sheets for their employee salespersons. When viewing inventory items, any salesperson is able to view certain client data on an item associated with their store domain, where they are able to see for whom an item is on hold or has been recommended, view both salesperson and client names associated with their store, and for how much longer an item may be on hold. This allows a salesperson to understand when a held item might be coming off of hold in the future, such that it may be available for them to hold for their own client.

Expiring Hold Tags

When a hold tag's timing expires, the items are taken off of hold and made available within the store's inventory again, for that salesperson or other salespersons to hold for other clients. Prior to expiration, and also at the point of hold expiration, both the salesperson and the client are notified via the system, in case they would like to take any action before or after the expiration point.

Receiving Hold Tags/Style Sheets

When a hold tag or style sheet is sent to a client, they can receive a text message or email with a link to the hold tag/style sheet. That link directs the user to a non-searchable URL where they can immediately view their hold tag or style sheet without logging into an account. This viewing is available whether the user has a pre-account or a full account.

If the user only has a pre-account, they do not have access to any other hold tags or style sheets from the page they jumped to, but an offer to create a password is generated by the system in order to confirm a full account and see any other hold tags/style sheets sent to them, or the public shopping and other features on the site. When the user has a full account, they additionally have access to other hold tags and style sheets sent to them, as well as access to the full feature set within a client account.

Review Items

When a consumer receives a hold tag or style sheet, they are able to review items in summary and detail views, quickly understand whether the items are being held for them exclusively, and understand the date/time of any hold tag's expiration. Whether a user is a salesperson or a client, they have access to a number of different UI views whenever they are viewing items/inventory:

Summary View

The summary view is the main view by which a user can browse multiple items. The user is able to view multiple items at a time, with a few preset categorizations, with the default being by hold tag/style sheet (when appropriate), and the alternative categorizations being by item type (e.g., tops, dresses, pants, etc.) and by designer. Additional categorizations can be used. Users can see the basic actions that they can take on a hold tag or style sheet as a whole, e.g., purchase, hold, etc.

Quick View

The quick view is a mouseover/pop-up view with limited amount of detailed information about an item, including countdown timer for any hold on each item (e.g., 48 hours), and the basic actions that a user can take on an item, e.g., purchase, hold, etc.

Detailed View

The detail view includes the full detail about an item plus the actions that a user can take on the item. This detail view preferably includes any comments that a salesperson/store has made about an item that are designated for the user to see.

Sorting

Within the views, the user is able to sort by some limited number of attributes, e.g., highest priced, lowest priced, etc.

Act on Private Items

For any item that a client has been sent via a hold tag/style sheet, there are five main actions that they can take in addition to taking no action at all. Some of these actions change the status of the item, but other actions do not, as detailed below. Actions on items are tracked separately from the status of the items. The status immediately affects item availability in a store's inventory. The actions that are performed on each item is tracked as selling activity data that will later surface in reports that stores will want to analyze. Those with skill in the art will recognize that the actions described below are exemplary, and that any number or types of different actions can be used.

1. Decline Item

This action is available for items that have been sent to a client via hold tag. It is not necessary for a client to decline a style sheet item since it is not being held for the client anyway. When a user declines an item, the salesperson is notified, and the status of that item changes from being on hold with that client to being available again within the store's inventory.

2. Add to Dressing Room

A client is able to add any item received by hold tag or style sheet to a private “Dressing Room”, which is a virtual container generated and stored on the system that allows them to view multiple items from multiple salespersons in a single space, without viewing other items they may not desire, analogous to a try-on in a brick-and-mortar dressing room. When adding items to the Dressing Room, the items are considered copied, and no overt status change are made to the item, except a tracking in the system that the item was indeed put into the client's Dressing Room. That is, the data of the Dressing Room action is tracked in the system, but not necessarily exposed to salespersons in their UI. That data may be exposed via reporting, but can be kept private to the client only.

Clients are able to add items from their Closet to their Dressing Room, to help in the case that they are reviewing new items that may match well with an existing item they own. Again, this action is a copy from the Closet, and does not change the status of the item in any way.

When adding items to a Dressing Room, a client is able to save and edit their Dressing Room state at will, allowing them to mix and match items, and save the grouping for later consideration. They are able to save any dressing room state as a “Look” that gets stored in their closet. This helps consumers save a collection of items as one look that they can refer to in the future.

If the status of an item changes while it is copied/saved in a Dressing Room, the user is notified and it is clear in the UI. Further, if an item is added to the Dressing Room from a style sheet, and that item is actually no longer available in the store's inventory or in the client's size, the client is notified at that point as well.

3. Comment or Request Detail Via Note

Clients have the ability to comment or ask a salesperson for more detail about an item, hold tag or style sheet, beginning a note exchange, regardless of whether any notes were originally sent by the salesperson. Clients are able to write such notes in text, and creating one triggers a notification to the salesperson to reply. By default, such an exchange of notes is considered private conversations between two users, not posted for other users to see, regardless of whether an item is private or public. However, some implementations allow an option for clients to show their notes or create public notes.

Whether starting a new note or replying to a note originally sent by the salesperson, the status of any item is not affected, and all expirations and other status rules continue to apply, with notifications of any expected status changes displayed in the UI.

4. Request Hold on Item

When an item is sent to a client via a Style Sheet, clients have the ability to request to put an item on an exclusive hold with the store, in the case that the client would like to think about the item and does not want it sold to someone else, or for the reason that they would like to go to the store to try the item on. In requesting such a hold, the system checks to ensure that it is indeed in the store's system inventory and available in that client's size. If not, that unavailability information is displayed to the client immediately. If so, the status of the item changes to “hold requested”, which is slightly different than a full hold. This status makes the item unavailable in a store's system inventory so that no other salesperson can sell it. However, because the item was not previously set aside for the client in the physical store, the salesperson must first physically locate the item and set it aside successfully. If the salesperson successfully locates and sets aside the item, the salesperson is able to confirm the full hold to the system, notifying the client that the request for hold has been fulfilled, changing the status of the item to a standard hold. In the system, the item is unavailable to any other client when it is both requested to be on hold as well as already on hold.

The amount of time that an item can be on hold adheres to the preset time per store, and the hold action triggers an alert to the salesperson/store so that they can physically set the item aside. If an item is already on hold for the client (i.e. when sent via hold tag), the ‘request hold’ option need not be available, of course, and there is no way for a client to extend the hold time of an item already on hold for them.

When initiated by a client or consumer, there are a maximum number of items that can be put on hold at one time. That maximum limit is set at the system level, and adjustable per store. In other implementations, stores or salespersons can override the limit when requested by a client.

5. Purchase Item

Clients are able to indicate that they would like to immediately purchase an item, regardless of whether an item is on hold for them or not. If an item was sent via Style Sheet, where it was not already on hold for the client, the system immediately checks whether the item is still available in the store's system inventory in the client's size. If not, the system displays that unavailability information to the user. If the item is available in the system, the status of the item is changed to “purchase requested”, and a notification is sent to the salesperson that the client would like to purchase the item. The process is then similar to the “hold requested” state described above, where the item was not previously set aside for the client in the physical store and the salesperson must first physically locate the item and set it aside successfully. Once set aside, the salesperson is able to confirm the request for purchase to the system, notifying the client that the request for purchase has been fulfilled, changing the status of the item to a standard purchase. In the system, the item is unavailable to any other client when it is both requested to be purchased as well as already purchased.

If an item was sent via hold tag to the client, items are immediately altered in status to “purchased” where they are unavailable in the store's system inventory and included in a user's shopping cart of multiple items, for later confirmation of true purchase, where multiple items from multiple stores can result in a single transaction.

In some implementations, once a user confirms their purchase, notifications are sent to the salespersons/stores from whom an item has been purchased, and salespersons process those transactions via manual charge/send mechanisms in their stores. Although unusual in standard e-commerce scenarios, luxury stores typically store the credit card information of their clients such that after phone and email conversations about an item, a salesperson can charge-send items to the client without re-transfer of the credit card information. The system can utilize this existing arrangement and not initially implement full ecommerce transactions via the site, but only the exchange of intent and confirmation mechanics. This allows the system to determine the best way of later implementing ecommerce transactions without full integration into the disparate financial systems that exist at brick-and-mortar stores.

The system can generate and execute agreements to ensure that clients have indeed granted official permission to charge a credit card on hand at the store, and that salespersons have the authority for such transactions. In some cases, credit card information is not on-hand at the store, and phone calls need to be placed to exchange such information. Once items are purchased, clients are able to review summary and detail information on orders placed, in transit, completed, returned, including tracking information.

6. Ignore Item

When a client has performed no action on hold tag items and the hold tag expires, this is considered a separate “ignore” action performed on those items rather than an outright decline. Stores and salespersons will want to understand when clients did not respond at all to a hold tag versus when they did review items and did not like or want them. In both cases, the status of the item changes back to available, but the action performed on it is distinctly ‘ignore’ rather than a ‘decline’.

The system can track each of these actions, as well as various states applied to the actions and transactions made by consumers, an perform analytics on them to generate a full set of metrics and measurements. These metrics can be displayed by other back-end components of the system, such as, for example, an integrated enterprise resource planning (ERP) module, a customer relationship management (CRM) module, or other web-based tools for optimizing the system or its processes.

Processing Client Actions

When clients act on items that a salesperson has sent to them, whether via hold tag or style sheet, salespersons are notified and have the ability to process each action appropriately. Some of this processing will be completely manual actions that will take place in the store, but salespersons still have the ability to mark, via the system, that they have indeed performed each process.

Process Requests for Hold

When an item is sent via Style Sheet, a client has the ability to indicate that they would like to put it on hold. In doing so, the salesperson that sent the item to that client is notified so that they can physically set aside that item in the store. This is to ensure that the item is indeed put on hold and not sold to any other client or walk-in customer. Once the salesperson has physically located the item in the store and put it aside for the client, they are able to confirm on the system that the hold has indeed been placed. This triggers a notification letting the client know that it is on hold for them, and what the expiration date/time is.

Process Purchased Items

When a client has indicated that they would like to purchase an item, the mechanics to process the order are slightly different depending on whether the item was already on hold for the client or not.

If the item was not yet on hold, the client would have altered the status of the item to “request to purchase”. Because the item may or may not still be available physically in the store, the salesperson must first physically locate the item in the store and put it aside for the client. At that point, they are able to confirm on the system that the item can indeed be purchased. This triggers a notification letting the client know that the availability and purchase are confirmed, and processing will be taking place from there.

In order to process a confirmed purchase of an item, the system provides the salesperson with the list of items purchased plus the shipping information for the client's order. It is then up to the salesperson to use the client's credit card on file at the store and perform a charge-send for that client via the normal methods they use in-store, i.e., via their own cash register. If the client's credit card is not yet on file, then phone/email contact takes place outside of the system, or via the system, in order to obtain it.

Once the transaction takes place, the system provides the ability to input tracking information for the order as well as print out an informational insert and shipping label to be used with the shipment. The informational insert provides basic information about the order, return information and an optional personal note from the salesperson. At the point that the insert/label is printed, a notification is sent to the user with their order and tracking information, confirming that the purchase has been processed. Setup of an order's informational information may be slightly custom per retailer. In other implementations, the payment processing is handled via the system site.

On the client side, multiple tracking numbers from multiple stores and salespersons are associated with a single transaction that the client placed. The system site can account for this, ensuring that each sub-order from a different store is still organized under the single transaction.

7. Shipping

The site offers a choice of shipping methods specific to each store, including cost estimation. Each order is limited to a single shipping address, but allows gift purchases. Even though the site is designed to be for self-use, wives may be purchasing for husbands and personal assistants may be shopping on behalf of employers, etc.

8. Order Confirmation & Tracking

Confirmation of an order results in an alert generated by the system to the store/salesperson to fulfill order, as well as tracking information to user.

Process Declined Items

When a salesperson is notified that a client has declined an item that was on hold for them, that item immediately becomes available in the store's system inventory, where any of the store's salespersons can once again send a hold for that item out to any other client. However, if the item is not immediately held for another client, it is up to the salesperson to physically remove the item from the store's inventory of held items, so that it can also physically be sold on the floor at the store. The system site allows the salesperson to indicate that they have performed this in-store action, so the salespersons can keep track of which items they have physically moved and not.

Reply to Comments/Requests in Notes

When a salesperson is notified that a client has provided comments or asked questions about a hold tag, style sheet or individual items, the salesperson is able to quickly reply to these comments/questions as a sort of chat trail of queries and responses that are stored as part of the hold tag, style sheet or item. The system keeps track of which queries have been replied to and not, to ensure that salespersons keep up to date on their correspondence with clients.

Returns

The user is able to request return of any ordered item (within the return policy restrictions conveyed by the site and the store), via completion of an online form that may include issuance of an RMA number, etc. Doing so allows the user to print out return/shipping forms and labels, etc., via the system.

Once instructions are provided for the client to return an item, and the item is en route, the item status is changed to return requested, to indicate that the item will likely be returned to inventory. Once physically received in the store, where the salesperson reverses the purchase via their normal store procedures, the salesperson is able to confirm the return via the system site, whereby the item is officially changed to “available” again, though in the item's history for the store, the activity around its purchase and return is still recorded.

Public Shopping

Public shopping is defined as shopping that takes place between salespersons and consumers who are not connected to each other on the system site. It utilizes many of the mechanisms setup for private shopping, but because the users are not yet connected, only certain shopping features are available. The term “public” is not meant to imply that private shopping mechanisms become public, however, nor that previously private interactions will be publicly displayed on the site.

Public shopping allows consumers to view items on other stores that they are not connected to, providing greater access to items they may be interested in. It also allows stores to market to a wider audience than their existing clients, with the possibility of gaining new clients who wish to engage with them even more via private shopping. Overall, viewing public items is not the core use of the site, so is a secondary way of shopping on the site. However, it is a way that salespersons and stores can market to and gain new clients via the system.

Automatic Send/Post Public Style Sheets

In the course of creating hold tags and style sheets for private shopping clients, by default, the system automatically creates a public version of each private hold tag and style sheet, and posts it in the public shopping area of the site. Such a public version contains substantially the same information as the private version, with the exception that all information about the private client is removed. That is, in the public shopping area, consumers are able to see the exact hold tag/style sheet sent to a private client, but not see any information about the client themselves, nor any private notes/comments from the salesperson or that client.

Like private style sheets, such items are not on hold for any client/consumer and so are not removed from the system inventory availability. Even though private comments will be removed from the public version of the hold tag/style sheet, the salesperson can input comments on the public style sheet that are available for all users to see.

Browse Public Items Filtered by Profile

When items are displayed to consumers via public style sheets, they are able to view them whether they are clients of that salesperson/store or not. In viewing the items, they are able to view them globally across stores via standard categories, e.g., by item type such as dresses, pants, etc., or by designer, but they are able to view them by store and or by salesperson, where they could see them grouped on their original style sheet configuration. Even when viewed outside of a style sheet container, the item's salesperson name and store name is prominent, to help promote them.

When viewing public items, by default consumers only see those items that match their profile, especially for sizes. This helps users reduce the amount of items they see to only those items that would actually fit them or interest them. Consumers have the option to turn off the filtering by profile, but the default is that it is on.

Actions on Public Items

As in private shopping, consumers are able to act on any item they see in the public shopping area. In public shopping, however, there are only four main actions that they can take in addition to taking no action at all, with no option to decline nor ignore any public item. Some of these actions change the status of the item, but other actions do not, as detailed below.

9. Add to Dressing Room

A client is able to add any public item their private “Dressing Room”, the container discussed previously in this document. In every way, the function operates in the same manner as it does for private items.

10. Comment or Request Detail Via Note

Via the system, clients can comment or ask a salesperson for more detail about a public item, beginning a note exchange in the same manner that they would for a private item. By default, such an exchange of notes is considered public conversations, posted for other users to see. In every other way, the function operates in substantially the same manner it does for private items.

11. Request Hold on Item

Via the system, clients can request to put a public item on an exclusive hold with the store in much the same manner that they do for private items. In every way, the function operates in substantially the same manner it does for private items. If the item is already on hold for a private client, the system will indicate this to the user.

12. Purchase Item

Clients can indicate via the system that they would like to immediately purchase a public item. This function operates in the same manner it does for private items sent via Style Sheet (where such items are not on hold for the client). If the item is already on hold for a private client, the system will indicate this to the user. Since the consumer's credit card information will not be on-hand at the store, phone calls or other communication will need to be placed to exchange such information.

13. Waitlist Item

If the system indicates that an item is already on hold for a private client, at that point the consumer is able to request to be added to the waitlist for the item. When adding themselves to the waitlist, they are required to indicate whether they would only like to waitlist for the item in order to hold it or to purchase it. If the hold for the private client expires and there is a waitlist, then the item does not change its status from ‘hold’. It instead remains on hold, where the salesperson is then able to send it via private hold tag to the consumer who requested it, letting them know that they are now able to hold/purchase the item because of their place at the top of the waitlist. If there is a waitlist of multiple consumers, the sequence of hold-expire-waitlist-hold repeats with the next consumer on the waitlist.

Follow Salesperson

As a consumer browses style sheets in the public shopping area of the site, they may have an interest in learning more about a salesperson's style and service before wanting to connect to that salesperson for private shopping. The site offers an ability to ‘follow’ a salesperson, analogous to a Twitter ‘follow’ action, where all public style sheets posted by the system on behalf of that salesperson are sent to the consumer for review. The salesperson is notified that another consumer is following them, but they are not able to see who the consumer is.

Connect to Salesperson

When a consumer would like to connect to a salesperson, in order to engage in private shopping with that salesperson, they are able to easily request such a connection. The salesperson is notified that the new connection has taken place, where they are able to confirm the connection and send a reply message to that new client.

In addition, once a consumer has interacted with a salesperson in certain specific manners, that salesperson has the ability via the system to invite that consumer to become a connected client of theirs, to be able to engage in private shopping with them. In order to qualify for an invitation to be sent, the consumer must have completed one of the following actions with a salesperson:
Purchased a public item
Requested a hold on a public item
Commented/requested information on a public item to the salesperson

After any of these actions has been completed successfully, that salesperson can request a client connection to that consumer. Of course, a consumer can request to be connected to any salesperson at any time, but the ability for salespersons to initiate a connection will be much more restricted in this manner, simply to prevent abuse of the site to blanket-connect consumers who are unknown to a salesperson.

Shopping by Request

Shopping by request is the third way of shopping offered on the system site. This set of features improves upon the basic searching available on other sites, providing a more targeted ‘find’ function for consumers looking for a particular item. It augments the private and public shopping options, and is integrated with them.

Request Find of an Item

Consumers are able to describe an item on the system site using a template set of attributes plus free text and photo(s), and send such a request to any combination of connected and public salespersons on the site, for them to respond with a recommendation. When asking salespersons to find/match an item, input can be optional, where the request can be as vague as “evening gown” or as specific as “Prada Hobo Handbag Brown” with a photo from a 3rd party site. The consumer is able to input values for attribute information, as well as enter text that gives salespersons information on what the consumer is requesting. User is able to upload or provide a link to a photo. They are able to add items from their system closet to the request, e.g., to request a salesperson to help them match a top to an existing skirt in their closet.

When a request to find is sent, relevant profile information such as sizing is applied to the request, automatically completing any attribute values, to give salespersons more information on how to best match the request. If the salesperson is not connected to the consumer, however, a received request does not necessarily allow that salesperson to view the consumer's profile or closet. That permission is reserved only for connected salespersons. Once stores/salespersons post items they think match the consumer's request, the consumer can browse or act on item just like any other item

Respond to Find Item Requests

If a salesperson has been sent a request to find an item, they receive a notification, and have the ability to respond, via the system. To respond, the salesperson is able to view their store inventory, and create a hold tag or style sheet that responds to the consumer's request.

Browse Items Posted Against Find

When response hold tags and style sheets have been sent by salespersons, the consumer can browse each of them as a subset to their original request, and then use the standard private shopping features with any of the items.

Invitation to Connect Consumer as a Client

Once a consumer has interacted with a salesperson on a find request, that salesperson has the ability to invite that consumer to become a full client of theirs, to be able to engage in private shopping with them. This is in addition to the requirements stated previously.

Method and Frequency of Email/Messaging Notifications

Users are able to setup multiple methods of receiving notifications. The default and unchangeable alert is that users see their newly sent items when they login, where newly sent items are those that have been not previously viewed since last login. In addition, users are able to receive the same alerts via email or text message, or both, and are able to set the frequency for those alerts as hourly, daily, weekly or monthly.

The following notifications can be used, and this list is exemplary:

Salesperson Notifications
Note comments or requests for detail
Requests for hold
Requests for purchase
Purchases
Expirations
Declines
Requests to find
Requests to return
Invitations to connect

Consumer/Client Notifications
New hold tags/style sheets
Responses to requests for detail
Responses to requests for hold
Responses to requests for purchase
Expirations
Order status
Invitations to connect
Alerts via automated voice messages

Data Collection and Reporting

Data collection and a number of reports have already been described throughout this document. In exemplary preferred implementations, the following data is collected for analysis, reporting, and collaboration with other back-end tools and software:
Client activities
Item activities
Salesperson activities
Connection activities
Reports

General System Attributes

Database Access: the system preferably operates on any Open Database Connectivity-(ODBC) compliant, Structured Query Language (SQL) compliant database. This enables hardware independence and allows a variety of ODBC- and SQL-based applications and tools to access data stored in the product database. A single, robust, industry-standard database can be chosen as the reference database, and care must be taken to avoid development of features specific to that brand. Eventually, the system is easily portable to additional databases, to simplify development and minimize the risk of choosing one product. Thus, a high level of connectivity and openness is promoted.

The database can execute efficient remote communications, and supports any number of users, from a few to thousands of concurrent client users. Access to it is easy, and responses are fast. The database is maintenance-free, simple for a database savvy-user to use, and requires no extensive set-up or ongoing tuning by a database administrator. The database cleanly and easily recovers from errors, and easily expands to allow for growing user and item volumes.

Scalability: the system is a network-ready product due to its web-based, client-server architecture, but key to its ability to manage very large or very small retailers will be its extensibility. Transaction speed and volume are key to ensuring users do not feel encumbered by the update of the site every time they perform an action. Design tradeoffs can be made that will allow for initial speed and agility yet scale for future high-transaction traffic. The system is also extensible for third party developers.

Data Integrity/Validation: Any data entered into the system is validated real-time, and any errors reported real-time, especially when credit card data is eventually entered for purchases. Early validation is also important in preventing invalid or problematic items or orders from appearing to users.

Flexible Input: The product will provide standard input options: keyboard, mouse, arrow keys, etc., as well as touch-based technology as it exists in tablet-type computers using touch interfaces. This ease of entry facilitates user acceptability and adaptability. The system can also be configured for managing bar code information to facilitate easy recognition of items.

Security: The system as a whole is secure enough to satisfy retailer IS requirements. Each retailer can assign only certain users to certain features and/or critical operations, especially for sections such as reporting or store profile information. Via login/password level security, it is possible to restrict users and groups of users to perform only those functions considered appropriate for their positions, and to see only those items/functions considered appropriate. The system is able to produce reports on unauthorized attempts to improperly access features. The system can also retrieve lost password/account information via security questions and/or resend to email address. Lastly, encryption/security for credit card and other financial information is present.

Error Trapping: The product tracks both system and user errors. When the flow of operations is interrupted, error handling is clean, and enough information is trapped such that a retailer or salesperson can easily identify any stalled action and reconstruct it. The product also tracks user activity including all additions, changes, and deletions that occur. User errors include in the audit trail the names of the users who made the modifications and the time and date at which the modifications were made. This will help identify when and where productivity is enhanced or decreased due to user intervention. It will also help ensure that database records are not changed or deleted by mistake.

Wishlist

A wishlist includes items a user may want to or wishes to purchase in future, but has not yet done so. The following functions can be executed by the system using one or more computer processors:
Place item on wishlist: Add item to wishlist for potential purchase. User likes item but would not like to purchase it at the moment (for whatever reason). Items can accumulate on wishlist indefinitely.
Request wishlist item: Request item from wishlist allows user to see if item is still available because they now may wish to purchase it. First, the system determines if item is posted at all. If not posted, the system sends alerts to salespersons/stores that the user is looking for item. Salespersons can respond via the system by posting that item to just that user or to be matched to all users.
Review found wishlist item: Review found item, decide whether to purchase or not.
Purchase from closet wishlist: Friends can purchase items on a wishlist as gifts for user—“fashion registry”
Found wishlist item notifications: Users receive alerts generated by the system when a match has made for an item on their wishlist they requested to be found.
Respond to wishlist requests: Salesperson/store ability to review “wishlist” requests and post items that best match request.
Credit consumer loyalty program: Credit account for any items purchased via site. Returns are deducted from loyalty program.
Credit store loyalty program: Credit reward accounts for any items purchased from store to which the user belongs to their reward program. Does not require use of store credit card to credit account for points.
Customize summary list view: User can choose from some small number of summary list view customizations, e.g., small photos, larger photos, 12 per page, 99 per page, etc.
Simple feedback on matched items: the system can provide an ability to indicate “thumbs up/thumbs down” to any item, which helps tune profile to match or not match more items like the item in question. The system can also generate a dialog to ask users why they do not like an item, giving them limited number of reasons: do not like designer, do not like color, do not like overall, etc.
Shared comments on items: the system enables comment on any item, where comments will be shared with connected users who can also view the item.
Browse similar items: In a sidebar of a user interface generated by the system, items that are similar to the items the user is viewing can be shown, either via use of a recommendation engine based on items that other users have been interested in, or via pre-established similarities between items within the database.

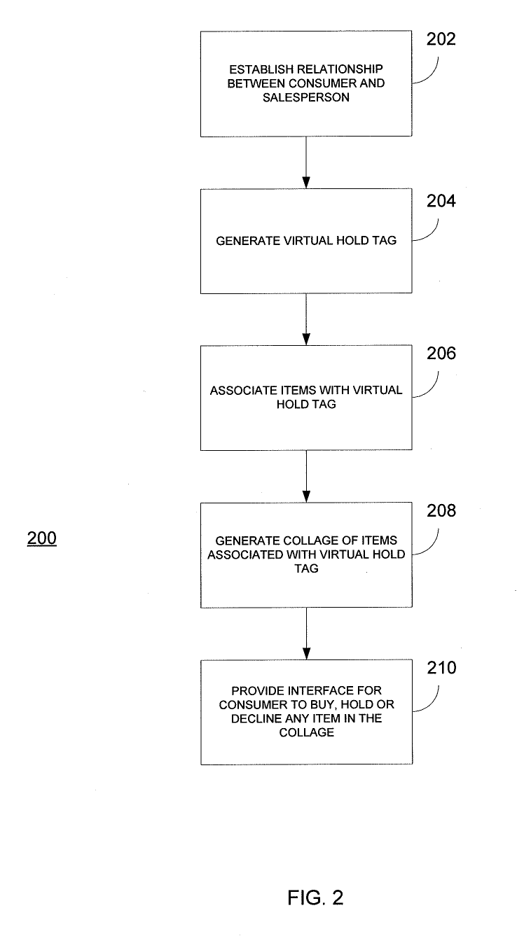

FIG. 2 is a flowchart of a method 200 executed by a personalized, automated shopping system. At 202, a relationship is established between a consumer and a salesperson for an online shopping transaction. The relationship is personalized, and as such, personal information is exchanged, preferably over a network and each party using a computer. The personal information can include, for example and without limitation: consumer preferences, age, size and other body-specific information, financial status, residence, and life experience. The personal information can also include, for example and without limitation: salesperson experience and background, taste descriptions, age, size and other body-specific information, and affiliation with a retailer or other commercial information. The relationship establishes an online process whereby the consumer has authorized, and the salesperson has accepted the obligation to hand-pick items during an online transaction or for an online purchase for the consumer.

At 204, a virtual hold tag is created. The virtual hold tag can be a window of an interface, a graphical representation of real hold tag or bin, or any other such generation. At 206, one or more items are associated with the virtual hold tag by the salesperson. The salesperson can “drag-and-drop” the one or more items into the graphical representation of the hold tag, mark the one or more items for the virtual hold tag, or by any other means of association. At 208, a collage of the items associated with the virtual hold tag is generated. The collage can be a pictorial representation of each item (such as a depiction of how the items might mix and match with each other). The virtual hold tag, the items, and the collage can be transmitted to the consumer via a network for display on a client computing device operable by the consumer, and under direction of the salesperson operating a computer affiliated with a retailer of the items. At 210, the computer provides, for the client computing device, an interface in which the consumer can buy, hold, or decline any item in the collage.

The system and method increase efficiency and productivity of store salespeople. The system and method allow salespeople to spend time on true sales efforts that are efficient and trackable, allowing them to measure their efforts not just in sales figures. They are able to more quickly contact their clients, with much more relevant and accessible information than a phone call or email provides. Because of this, they can spend less time on the mechanics of selling merchandise, and more time analyzing and repeating the actions to which their clients are most responsive, thus increasing their and their store's revenue.

Floor merchandise is marketed and moved online. The system and method provides stores with an online channel that utilizes their existing salespeople to market and sell the same goods they already have on their store floors gives store a new channel that augments their business rather than competes with it. It can increase turns and decrease the inventory that needs to be discounted at the end of the season.

The system and method can be used to expand a clientele base for both salespersons and store. The system allows stores to increase consumer awareness of their store and its goods, helping to expand a store's reach in a way that is cost-effective and achievable. They can easily market and sell to clients who are not located near the physical store, in a way they could never do previously, while providing this access in an unobtrusive manner.

The system and method provide real-time access to hundreds of stores. End users can shop from hundreds of luxury stores across the country, whether small or large, in real-time, and all on-line via an easy-to-use web interface. End users have access to stores they cannot possibly shop in the traditional manner, all without being forced to develop an in-person relationship with each store. Since the automation of their shopping saves time, end users feel they receive fast service. All of this encourages even higher usage of the website.

The system and method condenses immense volume into personalized finds, to allow stores and their salespeople to suggest and recommend items while dynamically filtering them to only those items that match their profile sizes and preferences, allowing the user to shop smartly and more efficiently. The end user saves time while experiencing greater shopping satisfaction given the items presented are personalized to them individually. The more consumers use the site, the more personalized the site will get, providing them the equivalent of zipping into a store and quickly finding just the right thing.

Consumers can simplify the relationships that help personalize their shopping without having to expend as much effort to forge true relationships that need to be fostered and maintained. A store's items are sent to users without relationship complications such as lack of communication, lack of previous purchase, lack of looking good enough to shop in the store—all the issues that may intimidate or at the very least put off some users from entering stores. The system and method provide a high level of control over what is presented, so consumers can trust the site, trust the salespeople who send them items, and trust the stores they seem to purchase from most often. This eliminates the need to search throughout the site inventory just to determine whether there is anything worth shopping for and whether a size is available, for example. With the described system and method, shopping is personalized, familiar and pleasant, regardless of whether a purchase is made or not.

The ability to personalize the system to meet each consumer's shopping preferences and complement the relationship workflow already present in stores results in an online product that is seemingly designed just for the luxury shopping market. In addition, the system adheres to industry standards and seamlessly integrates with existing operations of a store so that existing and new processes easily reside together.

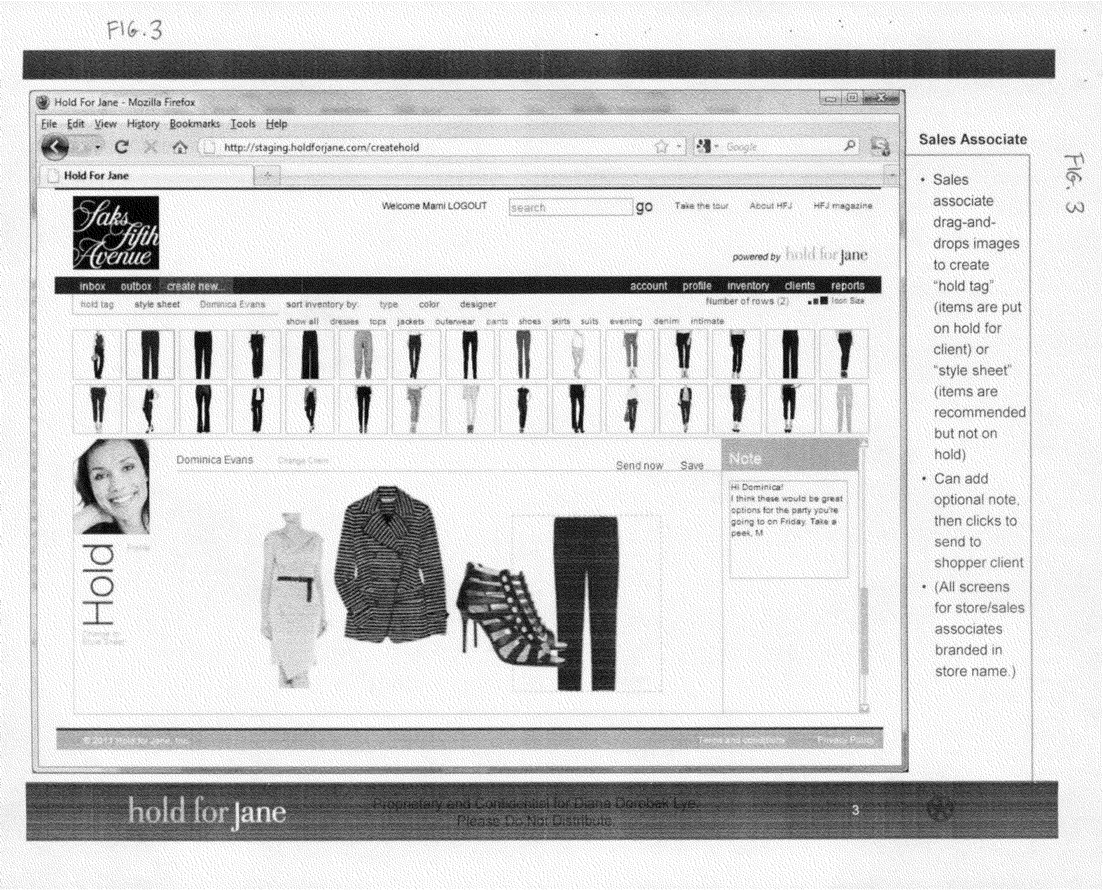

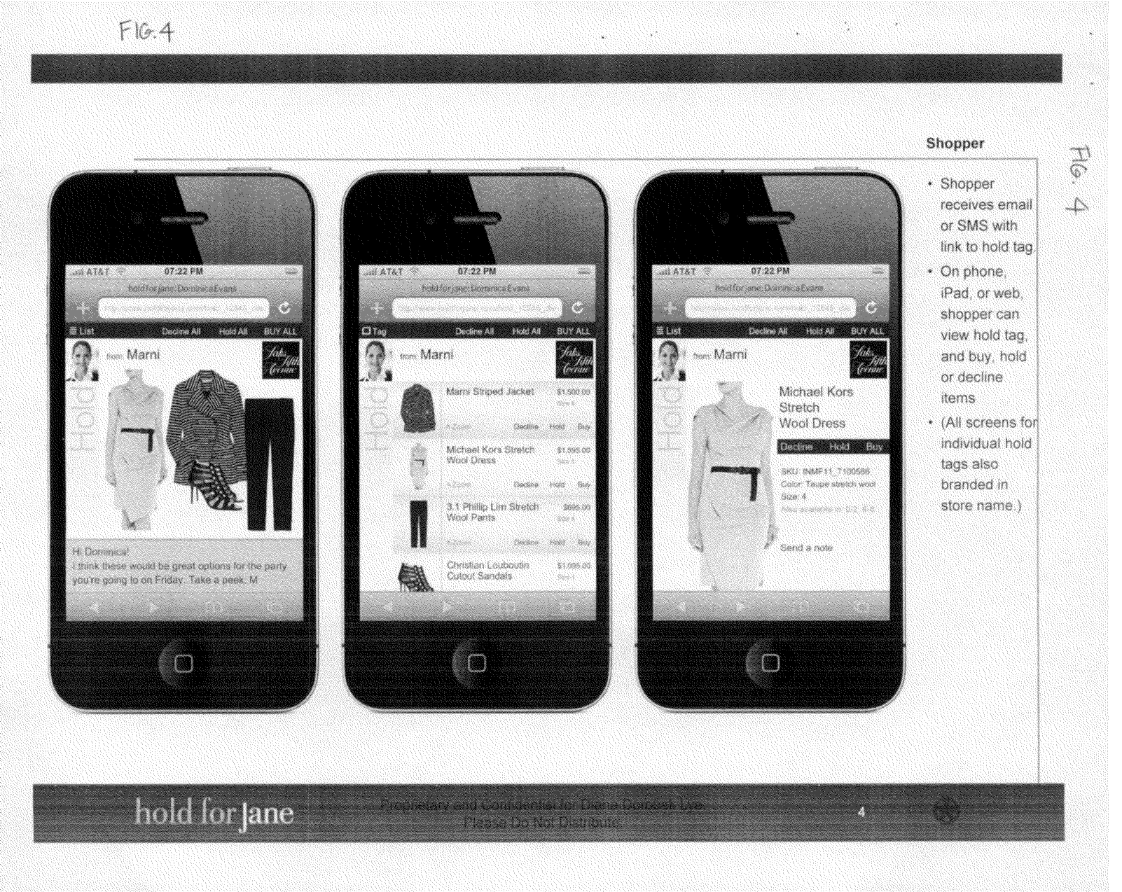

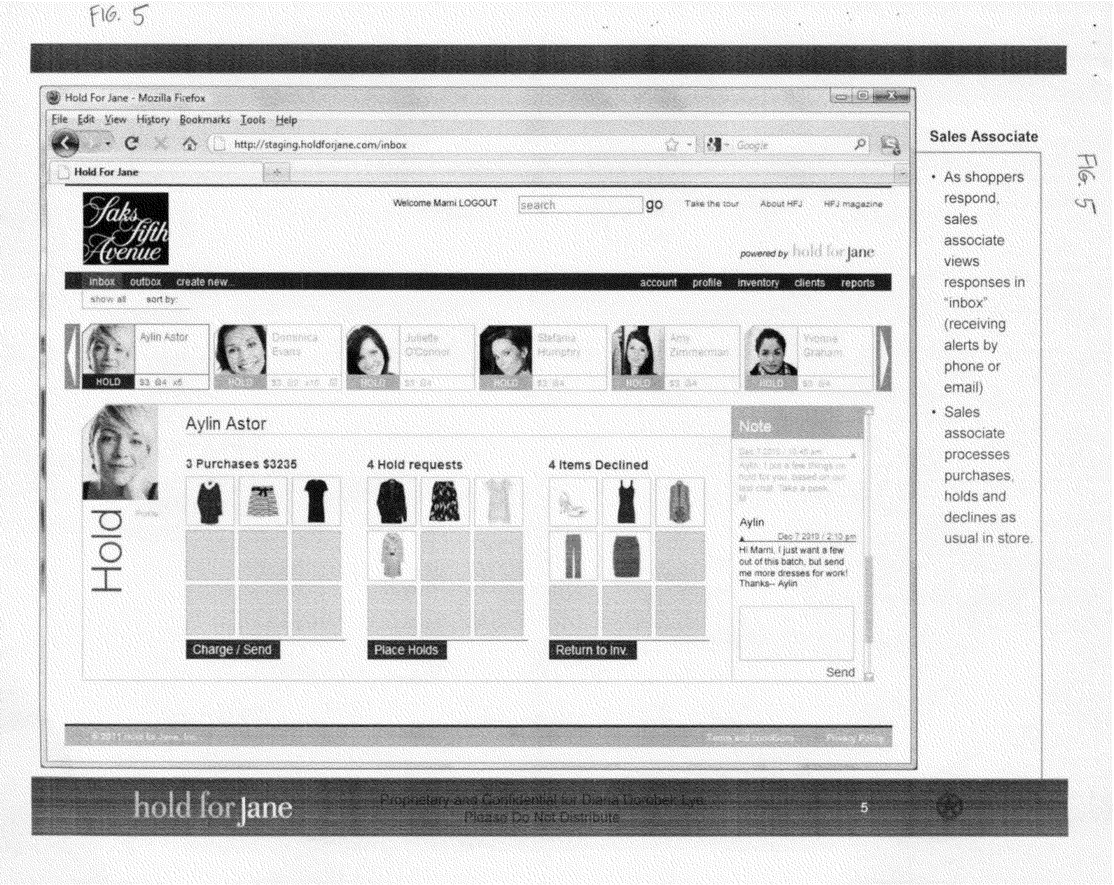

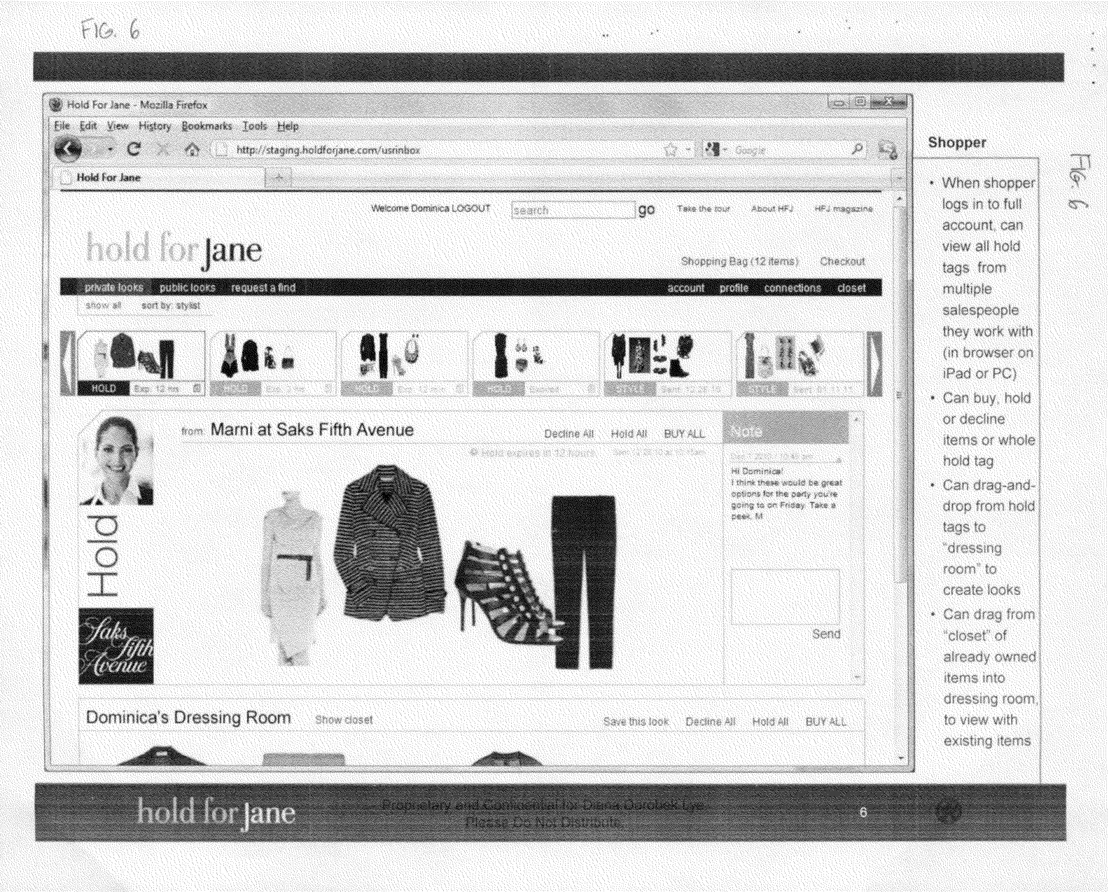

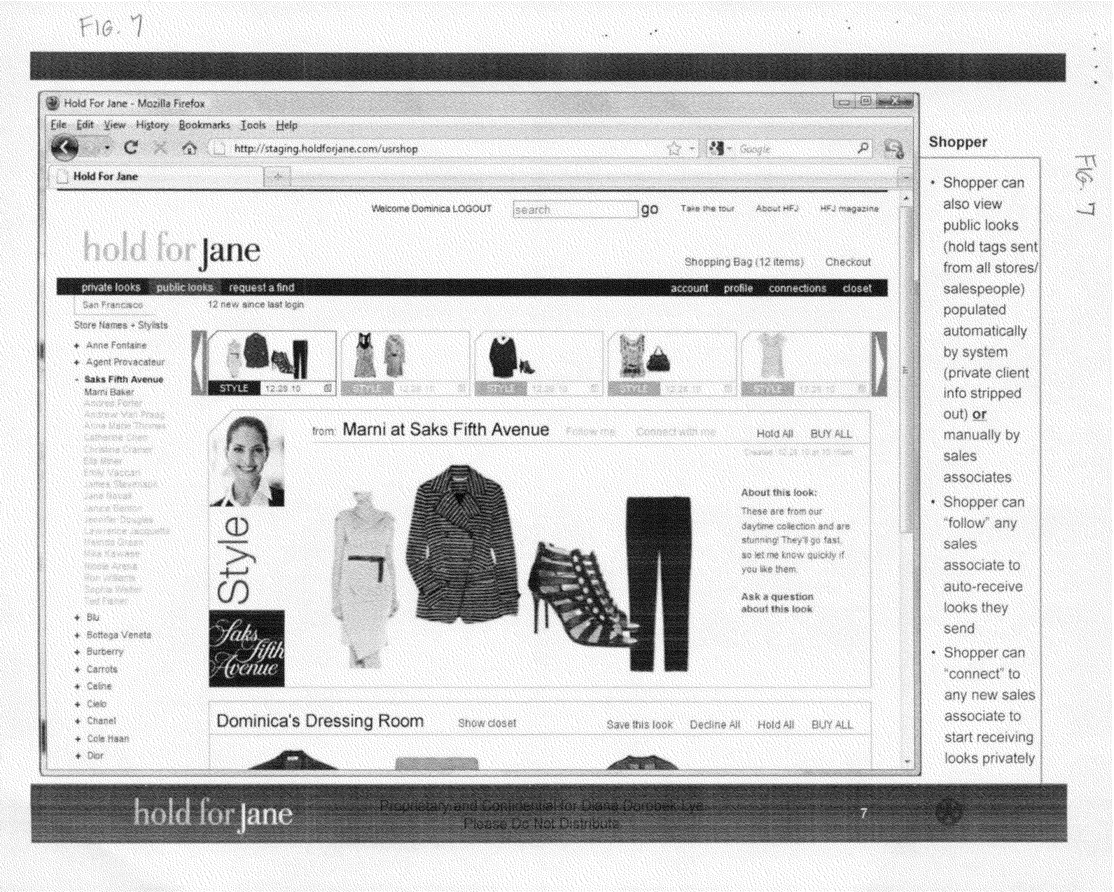

FIGS. 3-7 illustrate various graphical user interfaces of an online personalized and automated shopping system. FIG. 3 shows one or more items for sale, each of which can be dragged and dropped into a hold box or style sheet. FIG. 4 shows various GUIs for a mobile computing device, which the consumer can view to see the items being selected for them by a salesperson. FIG. 5 shows a GUI depicting a number of consumers associated with a salesperson, as well as consumer responses, inbox and other purchase information. FIG. 6 shows a salesperson's control interface, and a number of “dressing room” or “private looks” for a number of consumers associated with that salesperson. FIG. 7 shows another GUI and some social networking aspects of the system and method.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A computer-implemented method comprising:
generating, for a computer display, a virtual hold tag in a shopping application on a computer that provides one or more items for sale to a consumer operating a client computing device, the shopping application being associated with a retailer of the one or more items;
associating, by a computer, at least one of the one or more items with the virtual hold tag in the shopping application;
generating, by the computer, a collage of items associated with the virtual hold tag, the collage of items being a single visual representation of each item associated with the virtual hold tag;
transmitting, by the computer, the collage of items to the consumer via the client computing device; and
providing, by the computer for the client computing device, an interface configured to allow the consumer to buy, hold, or decline each item in the collage of items.

2. The computer-implemented method in accordance with claim 1, further comprising designating, by the computer, each item in the collage of items as being removed from inventory being held by the retailer of the one or more items.

3. The computer-implemented method in accordance with claim 2, wherein the designating causes each item in the collage of items to be no longer for sale by the retailer during the designating.

4. The computer-implemented method in accordance with claim 1, further comprising:
establishing, by the computer, a relationship between the consumer operating the client computing device and a salesperson operating the computer, the salesperson being affiliated with the retailer.

5. The computer-implemented method in accordance with claim 4, wherein the relationship includes exchanging personal information between the consumer and the salesperson via the client computing device and the computer, respectively.

6. A system comprising:
one or more programmable processors; and
at least one machine-readable medium tangibly encoding instructions that, when executed by the one or more processors, cause the one or more processors to perform operations comprising:
generating, for a computer display, a virtual hold tag in a shopping application that provides one or more items for sale to a consumer operating a client computing device, the shopping application being associated with a retailer of the one or more items;
associating at least one of the one or more items with the virtual hold tag in the shopping application;
generating a collage of items associated with the virtual hold tag, the collage of items being a single visual representation of each item associated with the virtual hold tag;
transmitting the collage of items to the consumer via the client computing device; and
providing, for the client computing device, an interface configured to allow the consumer to buy, hold, or decline each item in the collage of items.

7. The system in accordance with claim 6, wherein the operations further comprise designating each item in the collage of items as being removed from inventory being held by the retailer of the one or more items.

8. The system in accordance with claim 7, wherein the designating causes each item in the collage of items to be no longer for sale by the retailer during the designating.

9. The system in accordance with claim 6, wherein the operations further comprise establishing a relationship between the consumer operating the client computing device and a salesperson operating the computer, the salesperson being affiliated with the retailer.

10. The system in accordance with claim 4, wherein the relationship includes exchanging personal information between the consumer and the salesperson via the client computing device and the computer, respectively.
